(19) United States
(12) Patent Application Publication
(10) Pub. No.: US 2024/0426132 A1
(43) Pub. Date: Dec. 26, 2024

(54) FENCE MAINTENANCE TOOL

(71) Applicant: Jason Travis Rawson, Heffley Creek (CA)

(72) Inventor: Jason Travis Rawson, Heffley Creek (CA)

(21) Appl. No.: 18/337,847

(22) Filed: Jun. 20, 2023

(51) Int. Cl. E04H 17/26; B25F 1/00

(52) U.S. Cl. CPC E04H 17/265; B25F 1/00

(57) ABSTRACT

A fence maintenance tool that is configured to employed to assist a user in the performance of a plurality of tasks involved in the installation and repair of many different types of fences. The invention includes a body wherein the body is flat in form having a first portion and a second portion. The first portion and second portion are contiguously formed with the first portion being annular in shape having a post aperture. The second portion is generally rectangular in shape and includes a metal post aperture formed therein adjacent to the post aperture. The second portion further includes a jack aperture configured to engage with a lifting jack. The jack aperture has contiguously formed therewith a first slot and a second slot operable to engage wire tensioners. Wire apertures are bored through the second portion for engaging wire. Wire engagement grooves are formed on the opposing lateral edges.

### FIELD OF THE INVENTION

The present invention relates generally to equipment configured to assist with fence maintenance, more specifically but not by way of limitation, a tool configured to assist in the extraction of fence posts of various types wherein the tool of the present invention is further configured to engage other elements present in fencing such as but not limited to wire and tensioners.

### BACKGROUND

As is known in the art, there are numerous types of fencing that are employed along property perimeters and other desired locations. Fences such as wood privacy fences are commonly utilized in residential settings whereas alternate types of fencing such as barbed wire or chain link are more commonly utilized in commercial environments. For the latter, the installation involves the process of setting posts and running wire along a desired path. It is common to utilize metal posts wherein the metal posts are driven into the ground and can further be secured through materials such as but not limited to concrete. For the former, it is common to employ wooden posts wherein the lower end of the posts are buried in the ground and typically secured with concrete.

Both barbed wire fence and wooden privacy fences require routine maintenance and/or repair. Repairs and maintenance can include removal and replacement of posts as well as replacing and/or tightening of wire. Removal of fence posts can be an arduous task and often require a great deal of time. Additionally, during repair and maintenance of wire fences a user must have various tools in order to perform all of the needed tasks. Tools such as but not limited to wrenches and pliers are required to run or adjust wire and wire tensioners.

Accordingly, there is a need for a multi-purpose fence tool that is configured to provide assistance with fence post removal, wire manipulation and adjustment of wire tensioners.

### SUMMARY OF THE INVENTION

It is the object of the present invention to provide a multi-purpose fence tool that is configured to assist in performance of various activities required with fence maintenance wherein the present invention includes a body that is manufactured from metal and planar in manner.

Another object of the present invention is to provide a fence tool that is configured to assist in the execution of a plurality of activities required during performance of fence maintenance wherein the body of the present invention includes a first portion and a second portion.

A further object of the present invention is to provide a multi-purpose fence tool that is configured to assist in performance of various activities required with fence maintenance wherein the first portion is annular in shape having an aperture configured to receive a wooden fence post therein.

Yet a further object of the present invention is to provide a fence tool that is configured to assist in the execution of a plurality of activities required during performance of fence maintenance wherein the second portion is rectangular in shape and is contiguously formed with said first portion.

Still another object of the present invention is to provide a multi-purpose fence tool that is configured to assist in performance of various activities required with fence maintenance wherein the second portion includes a metal post aperture formed therein.

An additional object of the present invention is to provide a fence tool that is configured to assist in the execution of a plurality of activities required during performance of fence maintenance wherein the second portion further includes a jack receiving aperture formed therein.

Yet a further object of the present invention is to provide a multi-purpose fence tool that is configured to assist in performance of various activities required with fence maintenance wherein the second portion has formed on the side perimeter edges thereof wire grooves configured to receive and engage barbed wire.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top view of the present invention; and

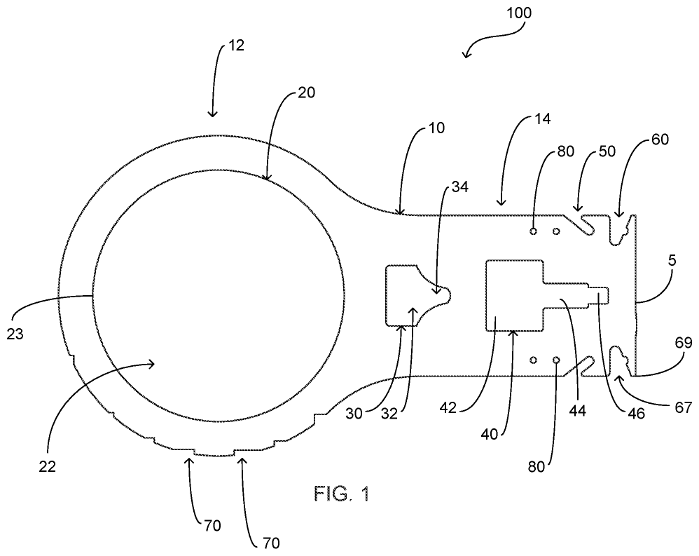

FIG. 2 is a perspective view of the present invention engaged with an exemplary post and lifting jack; and

FIG. 3 is a detailed view of the second portion of the body of the present invention.

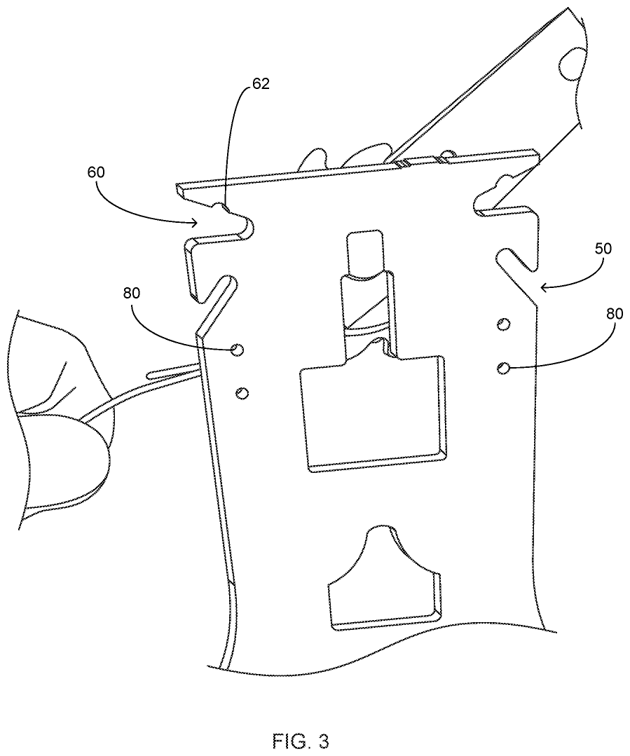

### DETAILED DESCRIPTION

Referring now to the drawings submitted herewith, wherein various elements depicted therein are not necessarily drawn to scale and wherein through the views and figures like elements are referenced with identical reference numerals, there is illustrated a fence maintenance tool 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

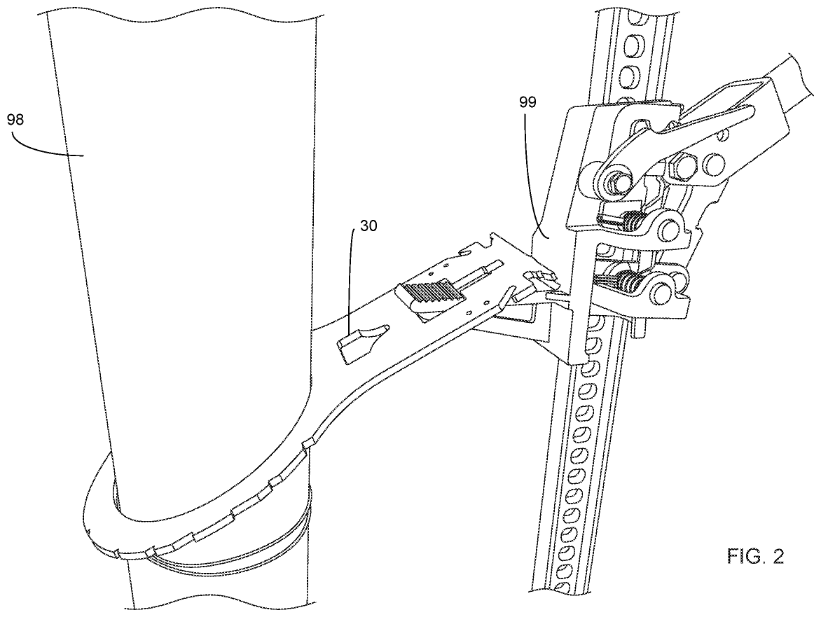

Referring in particular to the Figures submitted herewith, the fence maintenance tool 100 is comprised of a body 10. The body 10 is manufactured from a rigid material such as but not limited to metal. The body 10 is flat in form and it should be understood within the scope of the present invention that the body 10 could be provided in alternate sizes. The body includes a first portion 12 and a second portion 14 wherein the first portion 12 and second portion 14 are contiguously formed. The first portion 12 of the body 10 is annular in shape having post aperture 20. Post aperture 20 is annular in shape and includes inner perimeter edge 23 and opening 22. The post aperture 20 is configured to receive an exemplary fence post 98 therein wherein the inner perimeter edge 23 will bias against the fence post 98 and frictionally engage therewith to inhibit the fence maintenance tool 100 from moving during extraction of the fence post 98. The fence maintenance tool 100 provides a technique to engage and lift a fence post 98 as is illustrated herein in FIG. 2. To facilitate fence post 98 removal, an exemplary jack 99 is operably coupled to the fence maintenance tool 100 ensuing placing a fence post 98 through the post aperture 20. The jack 99 provides upward lift and the design of the fence maintenance tool 100 with the post aperture 20 engages the fence post 98 remaining in a fixed position thereon. While the post aperture 20 is illustrated herein as being annular in shape, it is contemplated within the scope of the present invention that the post aperture 20 could be provided in alternate shapes. Furthermore, it should be understood within the scope of the present invention that the post aperture 20 could be provided in alternate diameters so as to accommodate different sizes of fence posts 98.

Formed on the outer edge of the first portion 12 are a plurality of wire spacing notches 70. The wire spacing notches 70 are formed utilizing suitable techniques and are dispersed in increments along the outer edge of the first portion 12. The wire spacing notches provide specific measurements from the bottom edge 5 of the fence maintenance tool 100. The measurements provided by the wire spacing notches 70 provide a technique for a user of the fence maintenance tool 100 during installation of fence wire. It is contemplated within the scope of the present invention that the fence maintenance tool 100 could have various quantities of wire spacing notches 70 and it should be further understood that the spacing thereof could be provided in alternate distances.

Formed in the second portion 14 of the body 10 is metal post aperture 30. Metal post aperture 30 includes opening 32 wherein opening 32 is contiguous with lower portion 34. The metal post aperture 30 is configured to engage a metal t-post commonly utilized for various types of fencing. The lower portion 34 provides the ability for a user to insert a t-post through the opening 32. The metal post aperture 30 functions similarly to the post aperture 20 wherein ensuing insertion of the metal t-post into the metal post aperture 30 the fence maintenance tool 100 is biased thereagainst at an angle and is employed as leverage to provide lift upwards on the metal post either manually or assisted as with exemplary jack 99.

A jack aperture 40 is formed in the second portion 14 of body 10. The jack aperture 40 includes opening 42 wherein the opening 42 is configured to receive a portion of the exemplary jack 99 therein. The jack aperture 40 provides a technique for the fence maintenance tool 100 to be operably coupled with exemplary jack in order to facilitate upward movement on the fence maintenance tool 100. Contiguously formed with opening 42 extending towards bottom edge 5 is first slot 44. The first slot 44 is rectangular in shape and has a width that is less than the width of the opening 42. The first slot 44 is configured to engage a lifting chain during use of the fence maintenance tool 100. The first slot 44 is also sized so as to be utilized as a wrench for actuating mechanical rotating wire tensioners. A second slot 46 is contiguously formed with the first slot 44. The second slot 46 is rectangular in shape and has a width that is less than that of the first slot. The second slot 46 is provided to be utilized as a wrench for actuating mechanical rotating wire tensioners having a smaller size driver. Adjacent to the jack aperture 40 on each side thereof are wire apertures 80. The wire apertures 80 are annular in shape and are provided to be utilized to journal wire therethrough in order to employ the fence maintenance tool 100 for gripping, pulling and twisting wire. It is contemplated within the scope of the present invention that the body 10 could have formed therein alternate quantities of wire apertures 80 wherein the wire apertures 80 could further be placed in alternate locations on the body 10.

The fence maintenance tool 100 further includes a pair of wire engagement grooves 50. The wire engagement grooves 50 are formed on opposing edges of the body 10 and are angularly oriented so as to extend downward towards the bottom edge 5. The wire engagement grooves 50 are employed for gripping and engaging with barbed wire so as to manipulate the barbed wire as needed. This can include but is not limited to pulling and twisting barbed wire. While two wire engagement grooves 50 are illustrated on the embodiment of the fence maintenance tool 100 herein, it should be understood within the scope of the present invention that the fence maintenance tool 100 could be provided with more or less than two wire engagement grooves 50. Adjacent to the wire engagement grooves 50 proximate the bottom edge 5 are a pair of slot formations 60. The slot formations 60 extend inward towards the body 10 and have an opening 67 providing access thereto. The slot formations 60 are shaped to be utilized so as to assist in twisting wire for tensioning thereof. Slot formations 60 further include tab member 69 wherein the tab member 69 can be employed to pry underneath staples in order to assist in the removal thereof from a fence post 98. Furthermore, the shape of the slot formations 60 can additionally be employed to activate various styles of wire tensioners. It should be understood within the scope of the present invention that the body 10 could have formed therein more or less than two slot formations 60.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fence maintenance tool configured to be employed to a plurality of tasks involved with fence installation and repair wherein the fence maintenance tool comprises:
a body, said body being flat in form, said body having a first portion and a second portion, said first portion and said second portion being contiguously formed, said second portion having opposing lateral edges, said body being manufactured from a rigid material;
a post aperture, said post aperture being formed in said first portion of said body, said post aperture having an opening, said opening having an inner perimeter edge, said post aperture being of suitable size to have a fence post inserted therethrough;
a jack aperture, said jack aperture being formed in said second portion of said body, said jack aperture having an opening of suitable size so as to operably couple with an element on a lifting jack.

2. The fence maintenance tool configured to be employed to a plurality of tasks involved with fence installation and repair as recited in claim 1, wherein said first portion of said body further including a plurality of wire spacing notches form along an outer edge thereof, said plurality of wire spacing notches providing measurements from a bottom edge of said second portion of said body.

3. The fence maintenance tool configured to be employed to a plurality of tasks involved with fence installation and repair as recited in claim 2, and further including a metal post aperture, said metal post aperture having an opening operable to have a metal fence post inserted therethrough.

4. The fence maintenance tool configured to be employed to a plurality of tasks involved with fence installation and repair as recited in claim 3, wherein said metal post aperture includes a lower portion contiguously formed with said opening of said metal post aperture wherein said lower portion is tapered in shape.

5. The fence maintenance tool configured to be employed to a plurality of tasks involved with fence installation and repair as recited in claim 4, and further including a plurality of wire apertures, said plurality of wire apertures being annular in shape, said plurality of wire apertures being formed through said second portion of said body, said plurality of wire apertures operable to receive a wire therein.

6. The fence maintenance tool configured to be employed to a plurality of tasks involved with fence installation and repair as recited in claim 5, wherein said jack aperture further includes a first slot contiguously formed therewith, said first slot being contiguous with said opening of said jack aperture, said first slot extending away from said opening of said jack aperture, said first slot having a width that is less than a width of the opening of said jack aperture.

7. The fence maintenance tool configured to be employed to a plurality of tasks involved with fence installation and repair as recited in claim 6, and further including a second slot, said second slot being contiguous with said first slot opposite said jack aperture, said second slot extending away from said first slot, said second slot having a width that is less than a width of the first slot.

8. The fence maintenance tool configured to be employed to a plurality of tasks involved with fence installation and repair as recited in claim 7, and further including at least one wire engagement groove, said at least one wire engagement groove being formed on the lateral edge of said second portion of said body.

9. The fence maintenance tool configured to be employed to a plurality of tasks involved with fence installation and repair as recited in claim 8, wherein said second portion further includes at least one slot formation, said at least one slot formation being proximate said bottom edge, said at least one slot formation operable to engage wire or wire tensioners.

10. The fence maintenance tool configured to be employed to a plurality of tasks involved with fence installation and repair as recited in claim 9, wherein said at least one slot formation further includes a tab member, said tab member being adjacent an opening for said at least one slot formation.

11. The fence maintenance tool configured to be employed to a plurality of tasks involved with fence installation and repair as recited in claim 10, wherein said post aperture is annular in shape.

12. The fence maintenance tool configured to be employed to a plurality of tasks involved with fence installation and repair as recited in claim 11, wherein said body is manufactured from metal.
